(19) United States
(12) Patent Application Publication
(10) Pub. No.: US 2016/0105118 A1
(43) Pub. Date: Apr. 14, 2016

(54) POWER SUPPLY APPARATUS AND APPARATUS AND METHOD FOR CONTROLLING SWITCHED-MODE POWER SUPPLY (SMPS)

(71) Applicant: Samsung Electro-Mechanics Co., Ltd., Suwon-si (KR)

(72) Inventor: Sang Keun JI, Suwon-si (KR)

(73) Assignee: SAMSUNG ELECTRO-MECHANICS CO., LTD., Suwon-si (KR)

(21) Appl. No.: 14/643,728

(22) Filed: Mar. 10, 2015

(30) Foreign Application Priority Data
Oct. 10, 2014 (KR) 10-2014-0136559

(51) Int. Cl. H02M 3/335

(52) U.S. Cl. CPC H02M 3/33546

(57) ABSTRACT

A power supply apparatus may include: a pulse voltage generating unit generating a pulse voltage; a direct current (DC) voltage output unit converting the pulse voltage into a DC voltage; a sensing unit sensing a level of the DC voltage and a level of an output current output from the DC voltage output unit; a calculating unit calculating an amount of output power based on the level of the DC voltage and the level of the output current sensed by the sensing unit; and a controlling unit controlling the pulse voltage generating unit based on the amount of output power calculated by the calculating unit and an amount of reference power.

### CROSS-REFERENCE TO RELATED APPLICATION

This application claims the priority and benefit of Korean Patent Application No. 10-2014-0136559 filed on Oct. 10, 2014, with the Korean Intellectual Property Office, the disclosure of which is incorporated herein by reference.

### BACKGROUND

The present inventive concept relates to a power supply apparatus and an apparatus and a method for controlling a switched-mode power supply (SMPS).

Recently, the output power specifications and peak power specifications of power supply apparatuses and SMPS have increased, due to the user demand.

For example, an audio output load that receives a voltage from SMPS may require peak power having an amount thereof about five times greater than that of a typical load. In a case in which SMPS is designed to respond to a great amount of peak power, the size and price of the SMPS may be increased. In a case in which SMPS is designed to correspond to a typical load, the SMPS may not respond to an amount of peak power of the typical load, and thereby defects may be caused due to thermal runaway. Accordingly, numerous issues may arise in designing SMPS supplying a voltage to a high-output load.

For example, a typical load may have a peak power amount of 300 watts (W), while a peak power amount of 1500 W may be required for an audio output load. To solve this, SMPS having a peak power amount of about 800 W may be designed. However, in a case in which an output power amount of 1000 W or greater is output continuously, for example, for 24 hours or more, from an audio output load, a device included in the SMPS may be damaged and defects may occur due to thermal runaway.

Patent Document 1 below discloses SMPS and a method of protecting the same, but does not disclose details of the power supply apparatus and the apparatus and method for controlling SMPS according to an exemplary embodiment of the present inventive concept.

### RELATED ART DOCUMENT

### Patent Document

### (Patent Document 1) Korean Patent Laid-Open Publication No. 10-2006-0095644

### SUMMARY

An exemplary embodiment in the present inventive concept may provide a power supply apparatus and an apparatus and a method for controlling a switched mode power supply (SMPS).

According to an exemplary embodiment in the present inventive concept, a power supply apparatus may generate a pulse voltage and may convert the pulse voltage to a direct current (DC) voltage and output the DC voltage. The power supply apparatus may sense a level of the output DC voltage and a level of an output current to calculate an amount of output power, and may adjust the level of the DC voltage to be output based on the calculated amount of output power and an amount of reference power. The power supply apparatus may reduce an absolute level of the DC voltage in a case in which the amount of output power is greater than the amount of reference power, and in a case in which the amount of output power is less than the amount of reference power, the power supply apparatus may increase the absolute level of the DC voltage.

According to another exemplary embodiment in the present inventive concept, an apparatus for controlling SMPS may sense a level of a DC voltage and a level of an output current output from SMPS to calculate an amount of output power, and may change the level the DC voltage to be output by controlling the SMPS based on the calculated amount of output power and the amount of reference power. The apparatus for controlling the SMPS may compare an amount of output power prior to the level of the DC voltage being changed and an amount of output power subsequent to the level of the DC voltage being changed, to determine one of a plurality of modes as an operating mode based on a result of the comparison.

According to another exemplary embodiment in the present inventive concept, a method for controlling SMPS may include: sensing a level of a DC voltage and a level of an output current output from SMPS to calculate an amount of output power; comparing the calculated amount of output power with amounts of a plurality of different supplies of reference power; and determining a variation level of the DC voltage by controlling the SMPS based on a result of the comparison; and changing the level of the DC voltage.

### BRIEF DESCRIPTION OF DRAWINGS

The above and other aspects, features and other advantages of the present inventive concept will be more clearly understood from the following detailed description taken in conjunction with the accompanying drawings, in which:

FIG. 1 is a view illustrating a power supply apparatus according to an exemplary embodiment of the present inventive concept;

FIG. 2 is a view illustrating a power supply apparatus supplying a plurality of supplies of power;

FIG. 3 is a view illustrating an apparatus for controlling a switched-mode power supply (SMPS) according to an exemplary embodiment of the present inventive concept;

FIG. 4 is a graph illustrating a direct current (DC) voltage and an output current based on operation time of a power supply apparatus and an apparatus for controlling SMPS;

FIG. 5 is a flowchart illustrating a method for controlling SMPS according to an exemplary embodiment of the present inventive concept;

FIG. 6 is a detailed flowchart illustrating a method for controlling SMPS according to an exemplary embodiment of the present inventive concept; and

FIG. 7 is a flowchart illustrating a detailed algorithm using a method for controlling SMPS.

### DETAILED DESCRIPTION

Exemplary embodiments of the present inventive concept will now be described in detail with reference to the accompanying drawings.

The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art.

In the drawings, the shapes and dimensions of elements may be exaggerated for clarity, and the same reference numerals will be used throughout to designate the same or like elements.

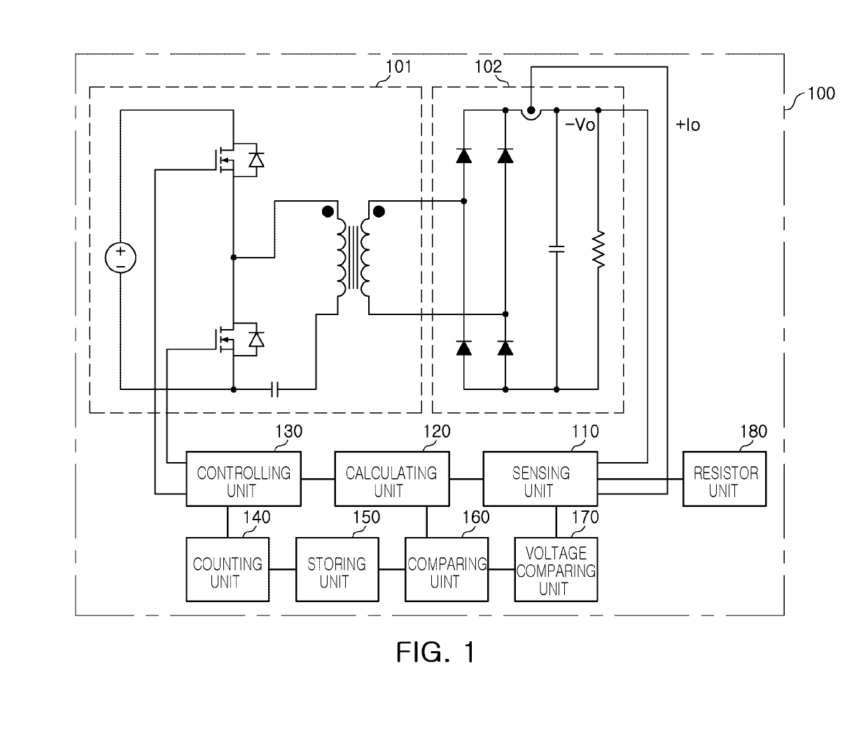

FIG. 1 illustrates a power supply apparatus according to an exemplary embodiment of the present inventive concept.

Referring to FIG. 1, a power supply apparatus 100 according to an exemplary embodiment of the present inventive concept may include a pulse voltage generating unit 101, a direct current (DC) voltage output unit 102, a sensing unit 110, a calculating unit 120, a controlling unit 130, a counting unit 140, a storing unit 150, a comparing unit 160, a voltage comparing unit 170, and a resistor unit 180.

The pulse voltage generating unit 101 may generate a pulse voltage. For example, the pulse voltage generating unit 101 may include a voltage source supplying a predetermined voltage, a semiconductor switch, and an LLC resonant circuit. The predetermined voltage output from the voltage source may be converted into a pulse voltage via an ON-OFF operation of the semiconductor switch and resonance of the LLC resonant circuit. Meanwhile, the voltage source may include a power factor correction (PFC) circuit to correct a power factor of the voltage source.

The DC voltage output unit 102 may convert the pulse voltage to a DC voltage Vo. The pulse voltage generated by the pulse voltage generating unit 101 may include all of a DC voltage, a sine wave voltage of a switching frequency, and a harmonic voltage. For example, as the pulse voltage passes through a low pass filter having a level of a cut-off frequency lower than a level of the switching frequency, the sine wave voltage of the switching frequency and the harmonic voltage may be filtered. Accordingly, the DC voltage output unit 102 may output the DC voltage.

The sensing unit 110 may sense a level of the DC voltage Vo and a level of an output current To output from the DC voltage output unit 102. For example, the sensing unit 110 may include a resistor having a high resistance level connected to an output end of the DC voltage output unit 102 to thereby sense the DC voltage and the output current as analog values. Also, the sensing unit 110 may convert the DC voltage and the output current sensed as the analog values into digital values using an analog-to-digital converter (ADC). Accordingly, the power supply apparatus 100 may perform calculating, controlling, counting, storing, and comparing by using the DC voltage and the output current as the digital values.

The calculating unit 120 may calculate an amount of output power based on the level of the DC voltage Vo and the level of the output current To sensed by the sensing unit 110. The amount of output power may be calculated by multiplying the level of the DC voltage by the level of the output current. Here, the level of the output current may not be constant. For example, the output current may be a sine wave current or a pulse current. Thus, the level of the output current may be measured during a predetermined period of time. Here, the calculating unit 120 may calculate an average of absolute levels of the output currents measured during the predetermined period of time. Accordingly, the calculating unit 120 may calculate the amount of output power by multiplying the level of the DC voltage and the average of the levels of the output currents.

The controlling unit 130 may control the pulse voltage generating unit 101 based on the amount of output power calculated by the calculating unit 120 and an amount of reference power. Here, the amount of reference power may be a maximum level a DC voltage or an average level of DC voltages that may be output from the DC voltage output unit 102.

In detail, in a case in which the amount of output power is greater than the amount of reference power, the controlling unit 130 may control the pulse voltage generating unit 101 to reduce an absolute level of the DC voltage, and in a case in which the amount of output power is less than the amount of reference power, the controlling unit 130 may control the pulse voltage generating unit 101 to increase the absolute level of the DC voltage. That is, the controlling unit 130 may determine whether the calculated amount of output power is great or small by referring to the amount of reference power, and may reduce or increase the absolute level of the DC voltage.

For example, the controlling unit 130 may reduce or increase a duty ratio of a pulse voltage to be generated, by controlling an ON-OFF time of the semiconductor switch included in the pulse voltage generating unit 101. The higher the duty ratio of the pulse voltage is, the higher the level of the DC voltage output from the DC voltage output unit 102 may be. Thus, the controlling unit 130 may adjust the level of the DC voltage output from the DC voltage output unit 102 by controlling the pulse voltage generating unit 101.

Also, the controlling unit 130 may compare the output power calculated by the calculating unit 120 with amounts of a plurality of different supplies of reference power to determine a variation level of the DC voltage based on a plurality of results of the comparison. For example, the amounts of the plurality of supplies of reference power may be set to the maximum level of the DC voltage that may be output from the DC voltage output unit 102, set to 90% of the maximum level of the DC voltage, and set to 80% of the maximum level of the DC voltage. Here, in a case in which the calculated amount of output power is less than 80% of the maximum level of the DC voltage, the controlling unit 130 may set the variation level of the DC voltage to +2V. Similarly, in a case in which the calculated amount of output power is greater than 80% of the maximum level of the DC voltage and less than 90% of the maximum level of the DC voltage, the controlling unit 130 may set the variation level of the DC voltage to +1V. Accordingly, the controlling unit 130 may control the pulse voltage generating unit 101 by precisely determining the variation level of the DC voltage.

In detail, the controlling unit 130 may set the variation level of the DC voltage Vo to a preset level, and may set the amounts of the plurality of different supplies of reference power by multiplying an amount of first reference power by a plurality of preset ratio. That is, the variation level of the DC voltage may be set to the preset level such as +1V, +2V, −1V, and −2V. Also, the amounts of the plurality of different supplies of reference power may be set to, for example, 100%, 90%, 80%, and 70% of the maximum level of the DC voltage that may be output from the DC voltage output unit 102. Here, the number of preset levels may be in proportion to the number of the plurality of different supplies of reference power.

The counting unit 140 may count the number of results in which the amount of output power is greater than the amount of reference power or the number of results in which the amount of output power is less than the amount of reference power from among a plurality of results of the comparing of the amounts of the plurality of different supplies of reference power with the amount of output power, the comparison performed by the controlling unit 130. Accordingly, the controlling unit 130 may determine a variation level of the DC voltage based on the number of results of the comparison counted by the counting unit 140. For example, the amounts of the plurality of different supplies of reference power may be set to the maximum level of the DC voltage that may be output from the DC voltage output unit 102, set to 90% of the maximum level, and set to 80% of the maximum level. Here, in a case in which the calculated amount of output power is less than 80% of the maximum level, a result of counting by the counting unit 140 may be 0 or 2. Similarly, in a case in which the calculated amount of output power is greater than 80% of the maximum level and less than 90% of the maximum level, a result of counting by the counting unit 140 may be 1. Accordingly, the controlling unit 130 may control the pulse voltage generating unit 101 by relatively rapidly and easily determining the variation level of the DC voltage.

The storing unit 150 may store an amount of output power prior to the level of the DC voltage Vo being increased or reduced by the controlling unit 130.

The comparing unit 160 may compare an amount of output power subsequent to the level of the DC voltage Vo being increased or reduced by the controlling unit 130, with the amount of output power stored in the storing unit 150. Thus, the controlling unit 130 may determine whether the output power is increased or reduced based on a result of the comparison by the comparing unit 160, and in a case in which the amount of output power is reduced, the controlling unit 130 may not reduce an absolute level of the DC voltage even when the reduced amount of output power is greater than the amount of reference power, and in a case in which the amount of output power is increased, the controlling unit 130 may not increase the absolute level of the DC voltage even when the increased amount of output power is less than the amount of reference power. That is, in a case in which the amount of output power is increased and is greater than the amount of reference power, the controlling unit 130 may control the SMPS to reduce the absolute level of the DC voltage. Also, in a case in which the amount of output power is reduced and is less than the amount of reference power, the controlling unit 130 may control the SMPS to increase the absolute level of the DC voltage.

The voltage comparing unit 170 may compare the level of the DC voltage Vo sensed by the sensing unit 110 with a level of a minimum voltage. In a case in which the absolute level of the DC voltage sensed by the sensing unit 110 is lower than an absolute level of the minimum voltage and the amount of output power is greater than the amount of reference power, the controlling unit 130 may not reduce the absolute level of the DC voltage. As a variation range of a level of the DC voltage is set based on the comparison by the voltage comparing unit 170, the controlling unit 130 may stably adjust the level of the DC voltage.

The resistor unit 180 may be connected to the DC voltage output unit 102 and may receive the DC voltage Vo applied thereto from the resistor unit 180. Here, the resistor unit 180 may include a variable resistor or an audio output load. The smaller a resistance level of the resistor unit 180 is, the higher a level of an output current output from the DC voltage output unit 102 may be. For example, in a case in which the resistor unit 180 is an audio output load, the resistor unit 180 may have a relatively low resistance level and a relatively great range of variation. Accordingly, an amount of output power output from the DC voltage output unit 102 may be increased considerably, and in a case in which the state of the amount of output power being great continues for a long period of time, elements included in the power supply apparatus 100 may be damaged due to thermal runaway. Thus, the controlling unit 130 may prevent damage caused by such thermal runaway by adjusting a level of a DC voltage to be output based on an amount of output power. Meanwhile, the controlling unit 130 may control the pulse voltage generating unit 101 such that a difference between a maximum level and a minimum level of the DC voltage is in a range of about 10 volts (V) and 20V. For example, in the case in which the resistor unit 180 is an audio output load, audio quality may vary substantially. Thus, the controlling unit 130 may adjust the level of the DC voltage to be in the range of about 10V to 20V in which audio quality does not vary substantially.

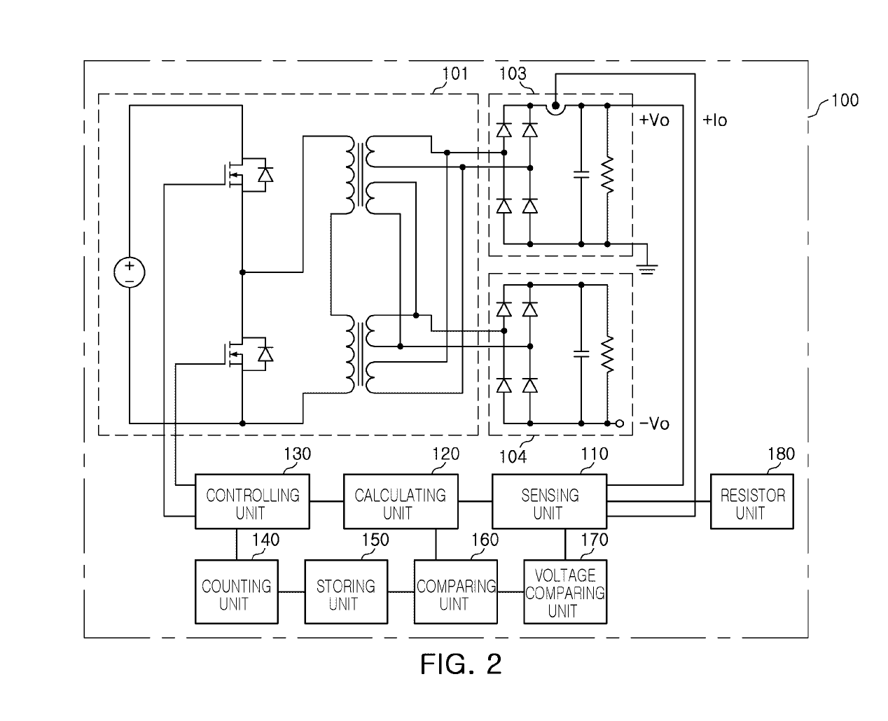

FIG. 2 illustrates a power supply apparatus supplying a plurality of supplies of power.

Referring to FIG. 2, the power supply apparatus 100 according to the exemplary embodiment of the present inventive concept may further include a first low pass filter 103 and a second low pass filter 104.

The pulse voltage generating unit 101 may generate a first pulse voltage having a positive level of an average voltage and a second pulse voltage having a negative level of an average voltage. For example, the pulse voltage generating unit 101 may output the pulse voltages as differential voltages. That is, an absolute level of the average voltage of the first pulse voltage and an absolute level of the average voltage of the second pulse voltage may be the same as one another.

The first low pass filter 103 may filter the first pulse voltage to output a positive DC voltage +Vo. The second low pass filter 104 may filter the second pulse voltage to output a negative DC voltage −Vo. That is, the power supply apparatus 100 may output both a positive DC voltage and a negative DC voltage, thereby supplying a plurality supplies of power.

The sensing unit 110 may sense the DC voltage +Vo of the first low pass filter 103 or the DC voltage −Vo of the second low pass filter 104 to sense a level of an output current of the first low pass filter 103 or a level of an output current of the second low pass filter 104. For example, in a case in which the pulse voltage generating unit 101 outputs pulse voltages as differential voltages, the sensing unit 110 may sense one of a plurality of DC voltages to be output. Accordingly, the controlling unit 130 may adjust all of the plurality of DC voltages, for example, a positive DC voltage +Vo and a negative DC voltage −Vo to be output, based on the sensed DC voltage.

The controlling unit 130 may control a duty ratio of the pulse voltage generated by the pulse voltage generating unit 101 based on the amount of output power calculated by the calculating unit 120 and the amount of reference power.

In detail, in a case in which the sensing unit 110 senses a DC voltage +Vo and an output current Io of the first low pass filter 103, and the calculated amount of output power is greater than the amount of reference power, the controlling unit 130 reduces the duty ratio of the pulse voltage generated by the pulse voltage generating unit 101, and in a case in which the output power is less than the amount of reference power, the controlling unit 130 may increase the duty ratio of the pulse voltage. Also, in a case in which the sensing unit 110 senses a DC voltage −Vo and an output current Io of the second low pass filter 104, and the amount of output power is greater than the amount of reference power, the controlling unit 130 may increase the duty ratio of the pulse voltage, and in a case in which the amount of output power is less than the amount of reference power, the controlling unit 130 may reduce the duty ratio of the pulse voltage.

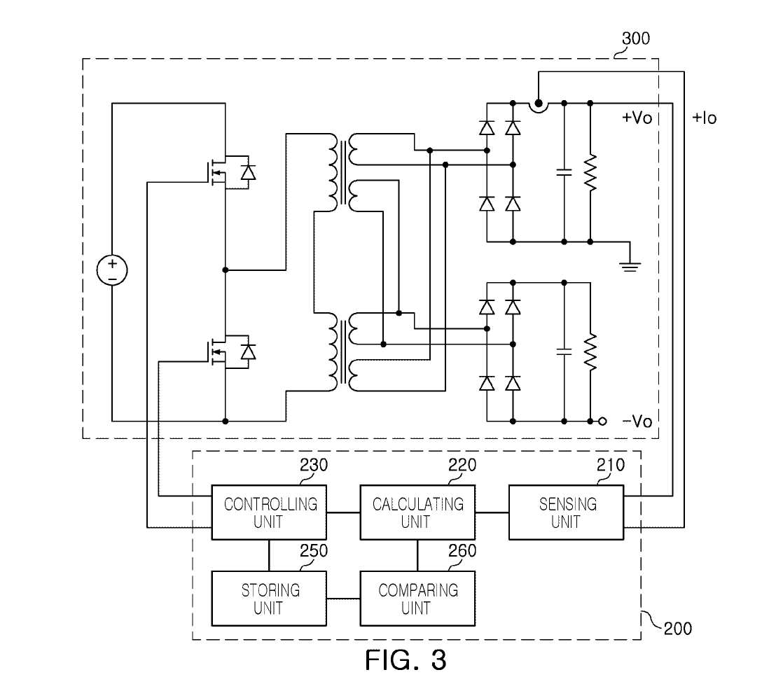

FIG. 3 illustrates an apparatus for controlling SMPS according to an exemplary embodiment of the present inventive concept.

Referring to FIG. 3, an apparatus 200 for controlling SMPS according to an exemplary embodiment of the present inventive concept may control SMPS 300 and may include a sensing unit 210, a calculating unit 220, a controlling unit 230, a storing unit 250, and a comparing unit 260.

Hereinafter, elements included in the apparatus 200 for controlling the SMPS according to the exemplary embodiment of the present inventive concept will be described. Contents identical to or corresponding to the description of the configuration of the power supply apparatus 100 described above with reference to FIGS. 1 and 2 will be omitted for conciseness.

The sensing unit 210 may sense a level of a DC voltage Vo and a level of an output current Io of the SMPS 300.

The calculating unit 220 may calculate an amount of output power based on the level of the DC voltage Vo and the level of the output current Io sensed by the sensing unit 210.

The controlling unit 230 may control the SMPS 300 based on the amount of output power calculated by the calculating unit 220 and an amount of reference power to change the level of the DC voltage Vo.

Also, in a case in which an amount of output power subsequent to the level of the DC voltage Vo being changed is greater than an amount of output power prior to the level of the DC voltage being changed, the controlling unit 230 may operate in a first mode, and in a case in which the amount of output power subsequent to the level of the DC voltage being changed is less than the amount of output power corresponding to the DC voltage prior to the level of the DC voltage being changed, the controlling unit 230 may operate in a second mode. Here, in the first mode, the controlling unit 230 may reduce or maintain an absolute level of the DC voltage and may not increase the absolute level of the DC voltage. Here, in the second mode, the controlling unit 230 may increase or maintain the absolute level of the DC voltage and may not reduce the absolute level of the DC voltage. That is, the amount of output power may be increased or maintained subsequently to being reduced, and may be reduced or maintained subsequently to being increased. By using a plurality of modes, the controlling unit 230 may prevent an abrupt change in the amount of output power and may stably adjust the level of the DC voltage.

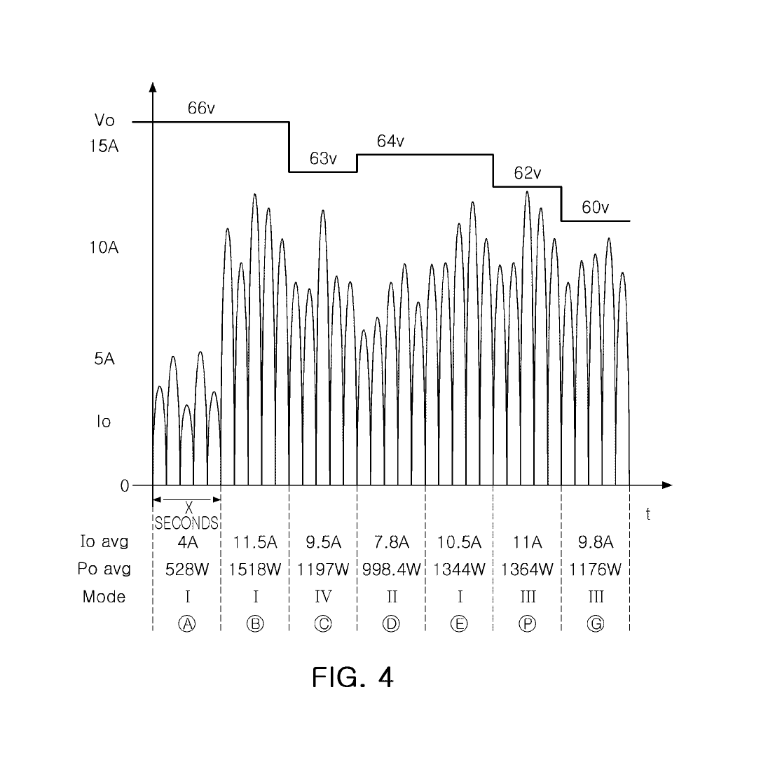

Also, the controlling unit 230 may compare the amount of output power calculated by the calculating unit 220 with amounts of a plurality of different supplies of reference power and may determine one of the plurality of modes as an operating mode based on a plurality of results of the comparison. For example, in a case in which the number of supplies of reference power is two, the number of the plurality of modes may be five. That is, the controlling unit 230 may compare the calculated amount of output power with amounts of the two supplies of reference power and may set a variation level of the DC voltage Vo to −2V, −1V, 0V, +1V, or +2V. Here, the controlling unit 230 may determine one of the five modes, from first to fifth modes, as an operating mode based on the variation level of the DC voltage Vo. Accordingly, the controlling unit 230 may adjust the level of the DC voltage output from the SMPS 200 relatively precisely. A description pertaining to the plurality of modes will be provided in detail with reference to FIG. 4.

The storing unit 250 may store the amount of output power prior to the level of the DC voltage being changed by the controlling unit 230.

The comparing unit 260 may compare the amount of output power subsequent to the level of the DC voltage being changed by the controlling unit 230, with the amount of output power stored in the storing unit 250.

FIG. 4 is a graph illustrating a DC voltage and an output current based on operation time of a power supply apparatus and an apparatus for controlling SMPS.

Referring to FIG. 4, levels of a DC voltage Vo and an output current Io based on control of SMPS that requires peak power having an amount equal to 1500 W are illustrated. Here, a first amount of reference power may be set to 1300 W. 90% and 110% of the amount of first reference power may be set to amounts of a plurality of supplies of reference power. Also, a mode in which an amount of peak power is 1170 W or less, which is 90% of the amount of first reference power or less may be defined as a first mode (Mode I); a mode in which an amount of peak power is 1170 W or greater may be defined as a second mode (Mode II); a mode in which an amount of peak power is 1300 W or greater, which is 100% of the amount of first reference power may be defined as a third mode (Mode III); a mode in which an amount of peak power is 1430 W or greater, which is 110% of the first amount of reference power may be defined as a fourth mode (Mode IV).

In section \textcircled{a}, in a case in which a level of the DC voltage is 66V and a level of the output current is abruptly changed, the level of the output current for x seconds is 4 amperes (A), and an amount of output power is 528 W (66V×4 A×2=528 W, two supplies of output power). An operating mode in a section subsequent to \textcircled{a} may be set to the first mode (Mode I), and the level of the DC voltage may not be changed therein.

In section \textcircled{b}, the level of the DC voltage is 66V without a change, the level of the output current is 11.5 A, and the amount of output power is 1518 W. An operating mode in a section subsequent to \textcircled{b} may be set to the fourth mode (Mode IV), and the level of the DC voltage may be changed to Vo*=Vo−3V.

In section \textcircled{c}, the level of the DC voltage is reduced to 63V, the level of the output current is 9.5 A, and the amount of output power is 1197 W. An operating mode in a section subsequent to \textcircled{c} may be set to the second mode (Mode II), and the level of the DC voltage may be changed to Vo*=Vo+1V.

In section \textcircled{g}, the level of the DC voltage is reduced to 60V, the level of the output current is 9.8 A and the amount of output power is 1176 W. In a case in which the level of the DC voltage is not reduced, the amount of output power is 1294 W (66V×9.8 A×2=1294 W). That is, as the controlling unit 130 or 230 adjusts the level of the DC voltage Vo, the amount of output power may be reduced by 118 W, and when the reduced amount of output power is converted to an amount of input power, 142 W of input power may be reduced under the assumption of 80% efficiency of power. Accordingly, damage to elements included in the power supply apparatus 100 or the SMPS 300 due to thermal runaway may be prevented.

Hereinafter, a method for controlling SMPS according to an exemplary embodiment of the present inventive concept will be described. Since the method for controlling the SMPS according to the exemplary embodiment of the present inventive concept may be performed in the power supply apparatus 100 or the apparatus 200 for controlling the SMPS described above with reference to FIGS. 1 through 3, a description of the method for controlling the SMPS having contents identical to or corresponding to the description of the power supply apparatus 100 or the apparatus 200 for controlling the SMPS provided above with reference to FIGS. 1 through 3 will be omitted for conciseness.

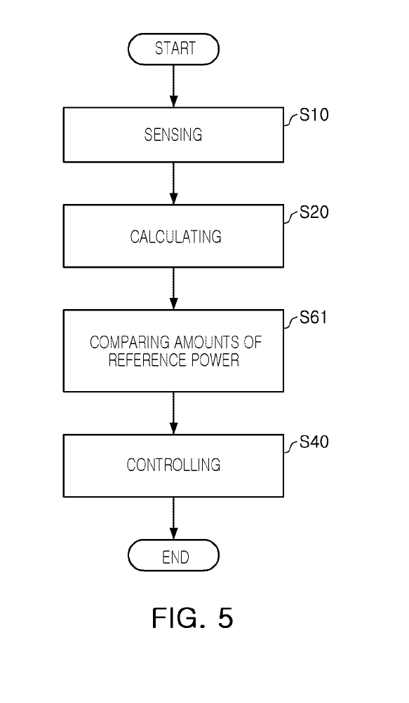

FIG. 5 is a flowchart illustrating a method for controlling SMPS according to an exemplary embodiment of the present inventive concept.

Referring to FIG. 5, the method for controlling the SMPS according to the exemplary embodiment of the present inventive concept may include a sensing operation (S10), a calculating operation (S20), a controlling operation (S30), and an operation of comparing amounts of reference power (S61).

In the sensing operation (S10), an apparatus for controlling SMPS may sense a level of a DC voltage and a level of an output current of SMPS.

In the calculating operation (S20), the apparatus for controlling the SMPS may calculate an amount of output power based on the level of the DC voltage and the level of the output current sensed in the sensing operation (S10).

In the controlling operation (S30), the apparatus for controlling the SMPS may determine a variation level of the DC voltage based on a result of the comparison in the operation of comparing the amounts of reference power (S61), and may control the SMPS to change the level of the DC voltage.

In the operation of comparing the amounts of reference power (S61), the apparatus for controlling the SMPS may compare the amount of output power calculated in the calculating operation (S20) with amounts of a plurality of different supplies of reference power.

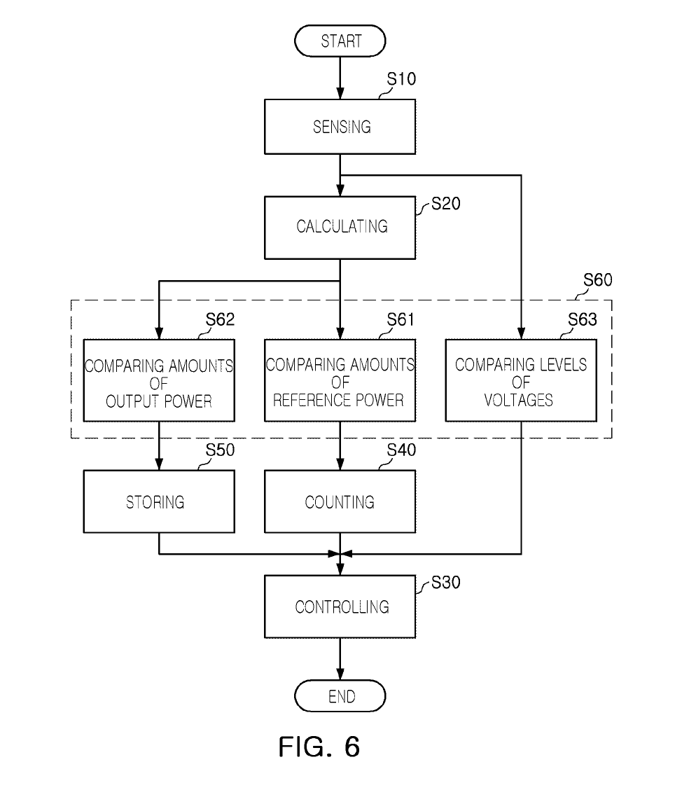

FIG. 6 is a detailed flowchart illustrating a method for controlling SMPS according to an exemplary embodiment of the present inventive concept.

Referring to FIG. 6, the method for controlling the SMPS according to the exemplary embodiment of the present inventive concept may further include a counting operation (S40), a storing operation (S50), a comparing operation (S60), an operation of comparing amounts of output power (S62), and an operation of comparing levels of voltages (S63).

In the counting operation (S40), the apparatus for controlling the SMPS may count the number of results in which the amount of output power is greater than the amount of reference power or the number of results in which the amount of output power is less than the amount of reference power from among results of the comparison in the operation of comparing the amounts of reference power (S61). Accordingly, in the controlling operation (S30), the apparatus for controlling the SMPS may determine the variation level of the DC voltage based on the number of results of the comparison counted in the counting operation (S40).

In the storing operation (S50), the apparatus for controlling the SMPS may store an amount of output power prior to the level of the DC voltage being increased or reduced in the controlling operation (S30).

The comparing operation (S60) may include the operation of comparing the amounts of reference power (S61), the operation of comparing the amounts of output power (S62), and the operation of comparing the levels of voltages (S63).

In the operation of comparing the amounts of output power (S62), the apparatus for controlling the SMPS may compare an amount of output power subsequent to the level of the DC voltage being increased or reduced in the controlling operation (S30), with the amount of output power stored in the storing operation (S50). Thus, in the controlling operation (S30), the apparatus for controlling the SMPS may determine whether the amount of output power is increased or reduced based on a result of the comparison in the operation of comparing the amounts of output power (S62), and in a case in which the amount of output power is increased and is greater than the amount of reference power, the apparatus for controlling the SMPS may control the SMPS to reduce an absolute level of the DC voltage, and in a case in which the amount of output power is reduced and is less than the amount of reference power, the apparatus for controlling the SMPS may control the SMPS to increase the absolute level of the DC voltage.

In the operation of comparing the levels of voltages (S63), the apparatus for controlling the SMPS may compare the level of the DC voltage sensed in the sensing operation (S10) with a level of a minimum voltage. In a case in which the absolute level of the DC voltage sensed in the sensing operation (S10) is higher than an absolute level of the level of the minimum voltage, and the amount of output power is greater than the amount of reference power, the apparatus for controlling the SMPS may control the SMPS to reduce the absolute level of the DC voltage in the controlling operation (S30).

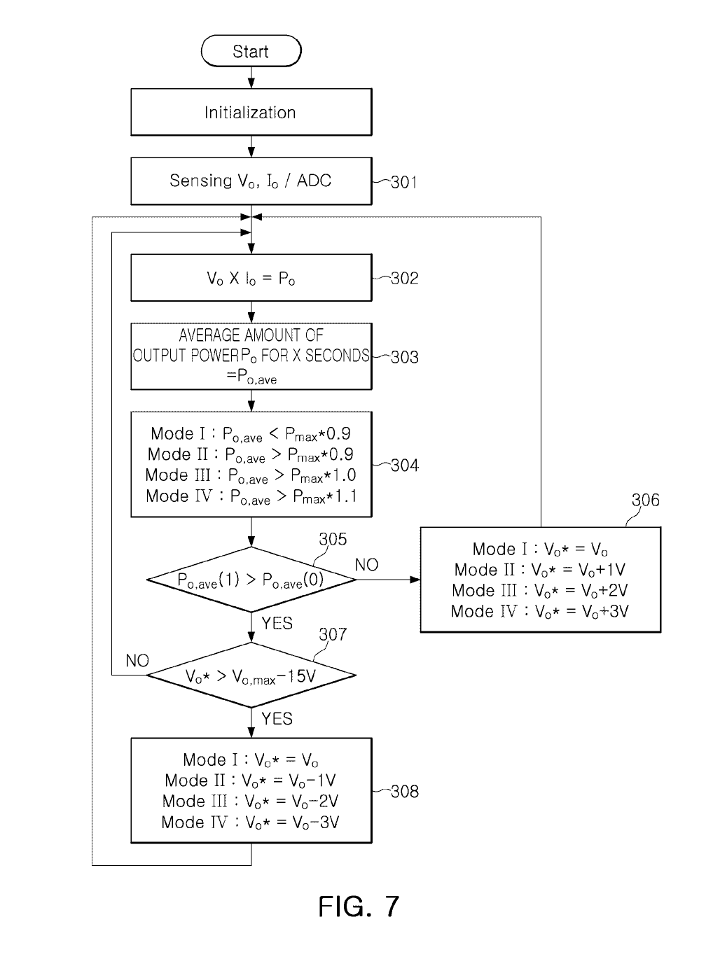

FIG. 7 is a flowchart illustrating a detailed algorithm using a method for controlling SMPS.

Referring to FIG. 7, in operation 301, an apparatus for controlling SMPS may sense a level of a DC voltage Vo and a level of an output current Io to calculate an amount of output power, and may send the sensed levels of the DC voltage Vo and the output current Io and the sensed amount of output power to an analog-to-digital converter (ADC).

In operation 302, the apparatus for controlling the SMPS may calculate an amount of output power Po by multiplying the level of the DC voltage and the level of the output current.

In operation 303, the apparatus for controlling the SMPS may calculate an average of plurality of amounts of output power Po for x seconds to calculate an average amount of output power Po.

In operation 304, the apparatus for controlling the SMPS may select an operating mode. In a case in which the amount of output power Po is 90% of an amount of reference power or less, a first mode (Mode I) may be selected; in a case in which the amount of output power Po is 90% of the amount of reference power or more, a second mode (Mode II) may be selected; in a case in which the amount of output power Po is 100% of the amount of reference power, a third mode (Mode III) may be selected; in a case in which the amount of output power Po is 110% of the amount of reference power, a fourth mode (Mode IV) may be selected.

In operation 305, the apparatus for controlling the SMPS may determine a variation level of the DC voltage by comparing an amount of stored output power with an amount of current output power.

In operation 306, the apparatus for controlling the SMPS may increase a level of a DC voltage Vo* based on the operating mode. In the first mode (Mode I), the level of the DC voltage may be maintained in a current state satisfying Vo*=Vo; in the second mode (Mode II), the level of the DC voltage may be changed to satisfy Vo*=Vo+1V; in the third mode (Mode III), the level of the DC voltage may be changed to satisfy Vo*=Vo+2V; in the fourth mode (Mode IV), the level of the DC voltage may be changed to satisfy Vo*=Vo+3V.

In operation 307, the apparatus for controlling the SMPS may verify whether the DC level of the voltage Vo differs from a level of a maximum voltage by a level equal to 15V or more.

In operation 308, the apparatus for controlling the SMPS may prevent damage to elements included in the power supply apparatus or the SMPS due to thermal runaway by reducing the level of the DC voltage Vo* based on the operating mode. The level of the DC voltage may not be changed in the first mode (Mode I); the level of the DC voltage may be changed to satisfy Vo*=Vo−1V in the second mode (Mode II); the level of the DC voltage may be changed to satisfy Vo*=Vo−2V in the third mode (Mode III); the level of the DC voltage may be changed to satisfy Vo*=Vo−3V in the fourth mode (Mode IV).

As set forth above, according to exemplary embodiments of the present inventive concept, by sensing an amount of output power and adjusting a level of DC voltage to be output, damage to elements included in the power supply apparatus due to thermal runaway may be prevented even when a voltage is supplied to a load that requires a relatively great amount of peak power and a relatively great amount of output power.

Also, according to exemplary embodiments of the present inventive concept, through the use of reference power, the comparing operation, and the operating mode, the level of the DC voltage to be output may be adjusted relatively rapidly and stably.

While exemplary embodiments have been shown and described above, it will be apparent to those skilled in the art that modifications and variations could be made without departing from the spirit and scope of the invention as defined by the appended claims.

What is claimed is:

1. A power supply apparatus comprising:
a pulse voltage generating unit generating a pulse voltage;
a direct current (DC) voltage output unit converting the pulse voltage into a DC voltage;
a sensing unit sensing a level of the DC voltage and a level of an output current output from the DC voltage output unit;
a calculating unit calculating an amount of output power based on the level of the DC voltage and the level of the output current sensed by the sensing unit; and
a controlling unit controlling the pulse voltage generating unit based on the amount of output power calculated by the calculating unit and an amount of reference power,
wherein the controlling unit controls the pulse voltage generating unit to reduce an absolute level of the DC voltage in a case in which the amount of output power is greater than the amount of reference power and controls the pulse voltage generating unit to increase an absolute level of the DC voltage in a case in which the amount of output power is less than the amount of reference power.

2. The power supply apparatus of claim 1, wherein the controlling unit compares the amount of output power calculated by the calculating unit with amounts of a plurality of different supplies of reference power and determines a variation level of the DC voltage based on a plurality of results of the comparison.

3. The power supply apparatus of claim 2, further comprising a counting unit counting a number of results in which the amount of output power is greater than the amount of reference power or a number of results in which the amount of output power is less than the amount of reference power, from among the plurality of results of the comparison,
wherein the controlling unit determines the variation level of the DC voltage based on the number of results of the comparison counted by the counting unit.

4. The power supply apparatus of claim 2, wherein the controlling unit sets a variation level of the DC voltage to a preset level, and determines the amounts of the plurality of different supplies of reference power by multiplying a first reference power and a plurality of preset ratio.

5. The power supply apparatus of claim 1, further comprising:
a storing unit storing an amount of output power prior to the level of the DC voltage being increased or reduced by the controlling unit; and
a comparing unit comparing an amount of output power subsequent to the level of the DC voltage being increased or reduced by the controlling unit, with the amount of output power stored in the storing unit.

6. The power supply apparatus of claim 5, wherein the controlling unit determines whether the amount of output power is increased or reduced based on a result of the comparison by the comparing unit, and in a case in which the amount of output power is reduced, the controlling unit does not reduce the absolute level of the DC voltage even when the reduced amount of output power is greater than the amount of reference power, and in a case in which the amount of output power is increased, the controlling unit does not increase the absolute level of the DC voltage even when the increased amount of output power is less than the amount of reference power.

7. The power supply apparatus of claim 1, further comprising a voltage comparing unit comparing the level of the DC voltage sensed by the sensing unit with a level of a minimum voltage,
wherein in a case in which the absolute level of the DC voltage sensed by the sensing unit is lower than an absolute level of the minimum voltage, and the amount of output power is greater than the amount of reference power, the controlling unit does not reduce the absolute level of the DC voltage.

8. The power supply apparatus of claim 1, further comprising a resistor unit connected to the DC voltage output unit and receiving a DC voltage,
wherein the resistor unit includes a variable resistor or an audio output load, and
the controlling unit controls the pulse voltage generating unit such that a difference between a maximum level and a minimum level of the DC voltage is in a range of about 10 volts (V) and 20V.

9. A power supply apparatus comprising:
a pulse voltage generating unit generating a first pulse voltage having a positive level of an average voltage and a second pulse voltage having a negative level of an average voltage;
a first low pass filter filtering the first pulse voltage to output a positive direct current (DC) voltage;
a second low pass filter filtering the second pulse voltage to output a negative DC voltage;
a sensing unit sensing a level of the positive DC voltage of the first low pass filter or a level of the negative DC voltage of the second low pass filter and sensing a level of an output current of the first low pass filter or a level of an output current of the second low pass filter;
a calculating unit calculating an amount of output power based on the level of the DC voltage and the level of the output current sensed by the sensing unit; and
a controlling unit controlling a duty ratio of the pulse voltage based on the amount of output power calculated by the calculating unit and an amount of reference power.

10. The power supply apparatus of claim 9, wherein in a case in which the sensing unit senses the level of the positive DC voltage and the level of the output current of the first low pass filter, and the amount of output power is greater than the amount of reference power, the controlling unit reduces a duty ratio of the pulse voltage, and in a case in which the amount of output power is less than the amount of reference power, the controlling unit increases a duty ratio of the pulse voltage, and
in a case in which the sensing unit senses the level of the negative DC voltage and the level of the output current of the second low pass filter, and the amount of output power is greater than the amount of reference power, the controlling unit increases a duty ratio of the pulse voltage, and in a case in which the amount of output power is less than the amount of reference power, the controlling unit reduces a duty ratio of the pulse voltage.

11. An apparatus for controlling a switched-mode power supply (SMPS), the apparatus comprising:
a sensing unit sensing a level of a direct current (DC) voltage and a level of an output current of SMPS;
a calculating unit calculating an amount of output power based on the level of the DC voltage and the level of the output current sensed by the sensing unit;
a controlling unit controlling the SMPS to change the level of the DC voltage based on the amount of output power calculated by the calculating unit and an amount of reference power;
a storing unit storing an amount of output power prior to a level of the DC voltage being changed by the controlling unit; and
a comparing unit comparing an amount of output power subsequent to a level of the DC voltage being changed by the controlling unit, with the amount of output power stored in the storing unit,
wherein in a case in which the amount of output power subsequent to the level of the DC voltage being changed is greater than the amount of output power prior to the level of the DC voltage being changed, the controlling unit operates in a first mode, and in a case in which the amount of output power subsequent to the level of the DC voltage being changed is less than the amount of output power prior to the level of the DC voltage being changed, the controlling unit operates in a second mode.

12. The apparatus of claim 11, wherein the controlling unit compares the amount of output power calculated by the calculating unit with amounts of a plurality of different supplies of reference power and determines one of a plurality of modes as an operating mode based on a plurality of results of the comparison.

13. A method for controlling a switched-mode power supply (SMPS), the method comprising:
sensing a level of a direct current (DC) voltage and a level of an output current of SMPS;
calculating an amount of output power based on the level of the DC voltage and the level of the output current sensed in the sensing of the DC voltage;
comparing the amount of output power calculated in the calculating with amounts of a plurality of different supplies of reference power; and
determining a variation level of the DC voltage based on a result of the comparing of the amount of output power with the amounts of the plurality of different supplies of reference power and controlling the SMPS to change the level of the DC voltage.

14. The method of claim 13, further comprising counting a number of results in which the amount of output power is greater than the amount of reference power or a number of results in which the amount of output power is less than the amount of reference power, from among a plurality of results of the comparing of the amount of output power with the amounts of the plurality of different supplies of reference power,
wherein in the controlling, the variation level of the DC voltage is determined based on the number of results of the comparison of the amount of output power with the amounts of the plurality of different supplies of reference power counted in the counting.

15. The method of claim 13, further comprising:
storing an amount of output power prior to the level of the DC voltage being increased or reduced in the controlling; and
comparing an amount of output power subsequent to the level of the DC voltage being increased or reduced in the controlling, with the amount of output power stored in the storing of the amount of output power.

16. The method of claim 15, wherein the controlling includes determining whether the amount of output power is increased or reduced based on a result of the comparing of the amount of output power subsequent to the level of the DC voltage being increased or reduced in the controlling, with the amount of output power stored in the storing of the amount of output power, and controlling the SMPS to reduce an absolute level of the DC voltage in a case in which the amount of output power is increased and is greater than the amount of reference power, and controlling the SMPS to increase the absolute level of the DC voltage in a case in which the amount of output power is reduced and is less than the amount of reference power.

17. The method of claim 13, further comprising comparing the level of the DC voltage sensed in the sensing, with a level of a minimum voltage, wherein in a case in which an absolute level of the DC voltage sensed in the sensing is higher than an absolute level of the minimum voltage and the amount of output power is greater than the amount of reference power, the SMPS is controlled to reduce the absolute level of the DC voltage in the controlling.
